(19) United States
(12) Patent Application Publication
(10) Pub. No.: US 2025/0245635 A1
(43) Pub. Date: Jul. 31, 2025

(54) SCENARIO-BASED DECISIONING BY MACHINE LEARNING MODELS FOR DATA PROCESSING RETRY SUCCESS

(71) Applicant: PAYPAL, INC., San Jose, CA (US)

(72) Inventors: Sana Haque, Fremont, CA (US); Ashwin Rao Gopalkrishna, London (GB); Mohammad Ahmadpoor, Chicago, IL (US); Miguel Fernandez-Montes Cuberta, San Francisco, CA (US); Devang Gaur, Mountain View, CA (US); Suraj Arulmozhi, Chennai (IN); Mahalinga Prabhu Sounderrajan, Chennai (IN); Ashok Subash, Chennai (IN); Pradeep Baliga, Pleasanton, CA (US); Shiwei Li, San Jose, CA (US); David Oliver, Chicago, IL (US); Spencer Regalado, Chicago, IL (US)

(21) Appl. No.: 18/608,047

(22) Filed: Mar. 18, 2024

(30) Foreign Application Priority Data
Jan. 31, 2024 (IN) 202411006488

(51) Int. Cl. G06F 11/07; G06Q 20/40

(52) U.S. Cl. CPC G06Q 20/0855; G06Q 20/405

(57) ABSTRACT

There are provided systems and methods for scenario-based decisioning by machine learning models for data processing retry success. A service provider, such as an electronic transaction processor for digital transactions, may detect a failure of data processing for a transaction or other request when processed with a data processing system. In order to minimize cost and wasted resources for retrying transactions that are likely to further fail, machine learning models may be implemented that generates a predictive score for whether a failed transaction is likely to be successful if retried with the data processing system. This may be done when the transactions are received or detected, which may occur prior to failures, for different scenario-based decisioning. Scenarios for failures may be processed by the models with different retry strategies and a predictive score may be used to predict a probability of success of the retry.

### CROSS REFERENCE TO RELATED APPLICATION

The present invention claims priority to India Provisional Patent Application Ser. No. 20/241,1006488, filed Jan. 31, 2024, all of which is incorporated herein by reference in its entirety.

### TECHNICAL FIELD

The present application generally relates to retrying failed data processing operations and transactions, and more particularly to machine learning (ML) models that determine whether to retry data processing failures based on scenario-based decisioning.

### BACKGROUND

Online service providers may provide computing services to different users, such as individual end users, merchants, companies, and other entities through online platforms, applications, websites, and the like. For example, online transaction processors may provide electronic transaction processing services through transaction processing websites and applications with corresponding platforms and processors accessible over a network. During electronic transaction processing via the online platforms and processor, the transaction processor may provide and/or interact with data processing services for processing transactions with financial instruments. For some transactions, an acquirer card processing system and platform may provide a card processor gateway and network to process payment card data, such as a credit card number and the like. As such, multiple different processors and/or separate systems may be involved in data processing. However, data processing requests between multiple systems and/or processors may fail at times, such as due to network communication issues, timeouts during decision service use, and other errors that may occur with data processors. While requests may be retried, if all failed data processing requests are retried, the transaction processor may waste computing and network resources, which is particularly wasteful for retrying requests with low to little likelihood of success. Conversely, without retrying some data processing requests, users may encounter significant friction, slow processing times, and application or website failures. Further, the transaction processor may encounter loss as well as increased resubmissions of requests, which causes delay and latency issues. As such, there exists a need for service providers to provide more intelligent and selective retry attempts based on failure and retry scenario decisions to provide faster and more reliable data processing.

### BRIEF DESCRIPTION OF THE DRAWINGS

FIG. 1 is a block diagram of a networked system suitable for implementing the processes described herein, according to an embodiment;

FIG. 2 is an exemplary computing environment in which a machine learning model is deployed to determine whether to retry failed electronic transaction processing requests based on scenario-based decisioning, according to an embodiment;

FIGS. 3A-3B are exemplary diagrams of machine learning models for predicting whether to retry a failed transaction processing request or other event based on features associated with failure and retry scenarios, according to an embodiment;

FIGS. 4A-4B are flowcharts for scenario-based decisioning by machine learning models for data processing retry success, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for scenario-based decisioning by machine learning models for data processing retry success. Systems suitable for practicing methods of the present disclosure are also provided.

In network communications, such as between online platforms and systems for service providers and end users' client devices, electronic platforms and computing architecture may provide computing services to users and computing devices. For example, online transaction processors may provide computing and data processing services for electronic transaction processing between two users or other entities (e.g., groups of users, merchants, businesses, charities, organizations, and the like). In order to assist in processing transactions for online transaction processors, payment networks and platforms may be utilized to process financial data and instruments. For example, an acquirer card processing system may interact with the transaction processor, as well as issuer payment systems, to process payment card data, such as credit or debit card data, when received with a transaction. The acquirer card processing system may process card data with any required transaction, user, and/or entity data (e.g., an amount, payee account, transaction timestamp or data, and the like), to provide payments from payment cards, such as debit and/or credit cards. Other types of financial instrument processing systems and/or financial institutions may process other financial or payment instrument information with transactions, such as bank account information, checks or checking information, and the like.

However, during data processing of requests and other calls to online platforms, failures may occur. For example, network communications may encounter an error where all or a part of the data is not properly transmitted to or received by the card processing system or other transaction processor. Some transaction processors may include internal systems of a single transaction or payment processor system, where calls between the processors or other internal systems and components may fail, go unanswered, encounter an error, or the like. At other times, a data processing failure, such as a timeout of a decision service or failure to process certain data, may occur. Each of these may therefore cause processing of the transaction and card or other payment data to fail and therefore not be processed by the transaction processor and/or corresponding external processing system, which may not cause the data to be processed and/or a payment to be issued for a transactions. Thus, certain data, network communications, and/or data processing operations may cause a transaction processing failure, which incurs loss, poor customer interactions, delayed processing times, and increased and/or wasted computing resource usage for resubmission of requests.

A transaction processor may execute a retry operation with the same data to attempt to process the request. However, in some cases, only a small amount of retries may be successful. Further, retries may have an associated cost due to the data processing and resources used, as well as the network communications and additional request and calls to the processors, networks, applications, application programming interfaces (APIs), and the like. As such, the transaction processor may utilize an ML model, neural network (NN), or other artificial intelligence (AI) system and engine to predict whether a retry of the data processing request may be successful if retried and resubmitted. For example, the ML model may provide a predictive score on a likelihood of success to retry processing of the transaction with the transaction processor based on a different scenario that caused the failure, as well as how the retry may be resubmitted, executed, or performed.

The predictive output, such as the score, decision, or other value, may further be used with a threshold and/or additional retry rules for one or more retry operations, processes, or another performable scenario to determine whether to execute the retry of the request that failed to be processed. If success is predicted (e.g., likelihood meeting or exceeding a threshold likelihood of success, having a sufficiently high score and passing rules to retry, etc.), then the retry may be executed and the request reprocessed using the corresponding retry process, selected processors, or other determined scenario for retrying data processing of the request. However, if retry is not determined to be likely to be successful or sufficiently meet the requirements, rules, and/or parameters for retrying, a failure and/or error message may issue to the user and/or system requesting the data processing with no retry attempts. In some embodiments, for the model thresholds, there may be specific model thresholds for different merchants and/or strategies used in a decision strategy layer for retry decisioning that may be synchronized through an offline mechanism, which may offer optimal model performance for each merchant while still and/or in-spite of using the same global model score between different models, merchants, and/or strategies.

In further detail, a service provider may provide electronic transaction processing to users and entities through digital accounts, including consumers and merchants that may wish to process transactions and payments. The service provider may also provide computing services, including email, social networking, microblogging, media sharing, messaging, business and consumer platforms, etc. In order to establish an account, these different users may be required to provide account details, such as a username, password (and/or other authentication credential, such as a biometric fingerprint, retinal scan, etc.), and other account creation details. The account creation details may include identification information to establish the account, such as personal information for a user, business or merchant information for another entity, or other types of identification information including a name, address, and/or other information. The entity may also be required to provide financial or funding source information, including payment card (e.g., credit/debit card) information, bank account information, gift card information, benefits/incentives, and/or financial investments, which may be used to process transactions. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services.

Thus, an online transaction processor or other service provider may execute operations, applications, decision services, and the like that may be used to process transactions between two or more users or entities. However, errors in data processing operations and engines, network communications, and other transaction computing services may cause a transaction to fail to be properly processed between the transaction processor and a backend card processing gateway and network, such as an acquirer card processing system. In order to minimize lost or abandoned data processing requests (e.g., from data processing failures) and wasted processing and network resources (e.g., from unnecessary retries), the transaction processing may use one or more intelligent ML or other artificial intelligence (AI) models and engines to predict retry success based on scenario-based decisioning, such as the failure scenario that caused the data processing of the request or other data to fail, as well as different strategies for retrying processing of the request or other data. The resulting prediction may then be used to determine whether to retry processing the request, retry using different parameters, or perform no further retry attempts.

In order to train the ML models, training data for the ML models may be collected and/or accessed. The training data may correspond to contextual features of the transaction and/or data processing request and “roll-up” features associated with the financial institution, retry strategy, or other past transaction history data that is indicative of historical success/decline patterns. As such, the training data may include samples and/or data associated with past failed data processing attempts of requests from clients, as well as retries of such data processing attempts. In some embodiments, such failures of data processing may correspond to transaction processing failures for past transactions when processing was attempted with different transaction processors, whether internal systems and components or external systems and/or components. For example, internal transaction processors may correspond to different data processing stacks, databases for account or financial instrument data, internally accessible funds and other funding instruments, and the like. External transaction processors may correspond to financial institutions and/or card processors and gateways, such as credit and/or debit card processing systems. As such, the training data may be specific to a certain card processing system (e.g., VISA®, MASTERCARD®, etc.) or may be across different card processor platforms. Additionally, the training data may include retry attempts and whether those retry attempts were successful or results in a further failure and retry of the processing was unsuccessful.

The training data may be based on a set of features that have been selected and/or engineered for the ML model(s) to be trained. For example, a set of ML model features for predicting retry likelihood of success may include those associated with the scenario-based decisioning to be performed for retry success, such as the contextual features and/or roll-up features. As such, the features and training data for these transaction processing failures may be associated with data regarding the underlying transaction, such as transaction, user, merchant, and other data for the requested transaction. The training data may also include financial source or instrument data, such as data associated with the payment card used to process the transaction, the payment network and network communications to transmit the payment card data to the card processing system, and/or data regarding a card processor and/or server system used with the card processing system to attempt processing of the transaction. In this regard, the card processing system may include a plurality of different card processors, such as a primary card processor and/or a secondary card processor. The primary card processor may be used for an initial transaction processing request, while the secondary card processor may be invoked during retry attempts; however, other configurations may also be utilized.

To train the ML model(s), a trainer may extract data for features, variables, and/or attributes of the ML model, where the data may be used to train the ML model. In this regard, a feature may correspond to a property or characteristic of the aforementioned data that may be used when generating predictions or other decisions by the model. The features may be used to determine mathematical relationships based on the ML algorithm to generate predictions and other decision-making outputs, such as a predictive score or output for the scenario-based decisions. For example, the features may be associated with the contextual features for the transaction amount, processor, card type, funding or financial instrument used, primary response code or the like to the processing request (e.g., decline or failure reason), and the like, as well as the roll-up features for the bank identification number (BIN), retry strategy, or other past transaction history data. Additionally, models may be trained for specific failure reasons and retry strategies for those failures, such as failure/decline categories and strategies that may be used to retry those failures or declines. In some embodiments, this may include retry strategies that may utilize or be based on a network token (NT) or other token-based, a real-time retry with a real-time billing service and/or billing component (e.g., MasterCard Automatic Billing Updater (MC-ABU)), a retry attempt by skipping an address field, using a zip code, or otherwise generalizing, relaxing or ignoring/skipping one or more fields for address verification, a retry with or using another processor or a secondary processor of the financial institution or acquirer processing system, or the like.

Training data may be merchant and/or financial institution-specific or agnostic and cross-merchants and/or financial institutions. The training data may then be used for training the ML model using a ML algorithm and a ML training process. In various embodiments, the ML model may use a gradient boosting machine (GBM) or light GBM model, an extreme gradient boosting (XGBoost) model, a random forest model, a tree-based algorithm model, or the like. Once the ML model(s) is/are trained, the ML model(s) may then be deployed in a predictive system for predicting retry attempt success and/or whether to execute a retry of a failed transaction processing attempt of a transaction based on failure and retry scenario-decisioning. In this regard, the ML payments when merchants or other payees call the transaction processor, which may include interactions with other external payment processors and/or financial instrument issuers (e.g., credit card issuers, financial institutions, etc.). The payment processing system may include one or more components and/or processors with corresponding logic to perform retry execution of failed transactions, payments requests, or other data processing requests based on scenario-based decision. The ML model(s) may also be deployed with rules that may limit and/or enforce other restrictions or requirements for retry attempt execution of failed data processing, such as a merchant specific cost or value, user or payer value, transaction or merchant specific failure or success indicators, and the like.

After being deployed, transactions and other data processing requests may be monitored as they are received and/or enter the transaction processor's system for processing. Instead of waiting for failures or declines of the transactions and/or requests to occur when processing, scenario-based decisioning may be performed at the outset when the transactions and/or other requests are detected based on the different scenarios for failure/decline and corresponding strategies for retrying. As such, predictive scores may be determined from the data load for the initial request, such as the merchant, transaction data, acquirer or other transaction processor (whether internal or external), and the like. The retry attempt engine may therefore extract data features used as input to the ML model (e.g., used as input to an input layer and/or nodes of the ML model). The ML model(s) for one or more retry strategies and/or other scenarios may then provide an output prediction or decision, such as a predictive score for retry success likelihood. In this regard, the predictive score may further correspond to a probability or likelihood (e.g., in percentage form or quantitative form), which may allow comparison to other predictive scores, a threshold, and/or costs for executing or preventing the retry attempt.

After determining the predictive score(s) for scenario-based decisioning, the predictive score(s) may be used to determine whether to execute a retry of the failed transaction with the card processing system. In this regard, the predictive score(s) may be compared to a threshold score or likelihood of success, which may be required to be met or exceeded to execute the retry. The score(s) may then be stored, such as cached in a short-term memory component or otherwise stored in a data storage component, system, database, or the like, for potential failure or decline of the transaction and/or request. For example, the scores or other inferencing by the ML models for retry success likelihood and/or eligibility may be determined simultaneously while or during the primary processing of the transactions. As such, if no failure occurs, after success, or after a period of time where retrying the transaction is unnecessary, the scores may be deleted, wiped, or removed from memory. This may occur where the primary processing of the transaction is successful or does not require retrying.

However, if a failure of a transaction processing attempt for a transaction occurs, the retry attempt engine may obtain data for the failure, such as transaction and/or financial instrument data (e.g., card data and any data associated with requesting processing of the card data with a card processing system). The data may then be used to select or identify one or more of the score(s) for determining whether to execute a retry attempt. A retry attempt may then be executed if sufficiently meeting or exceeding the threshold, rules, or other requirements, or may be declined if the retry attempt is does not meet or exceed the threshold (e.g., is at or below) and therefore determined to be too risky, unlikely to succeed, or the like. The retry attempt may use the corresponding strategy for the score.

Thus, the online transaction processor may execute intelligent decisioning for different failure or decline scenarios when retrying data processing, which allows for the transaction processor to determine whether to execute retries. This scenario-based decisioning for retry attempts allows the transaction processor to conserve processing resources and network communication bandwidth, usage, and resources using a predictive model. This reduces processing time, cost, and resource usage with computing systems, thereby providing improved data processing systems. This also reduces processing loads and network communication consumption for card processing systems, gateways, and network, which further improves performance of such data processing and computing systems. Further, the online transaction processor may perform the scenario-based decisioning when transactions or other data processing requests are received and/or detected for different retry strategies, which may be performed prior to failures or declines occurring. As such, the scores or other output decisions and predictions may be used to provide faster and more real-time retry decisions when a failure or decline actually occurs, which provides for faster responses to users, merchants, or other requestors. Thus, the online transaction may implement an intelligent retry system that significantly improves efficiency and response in data processing while decreasing wasted computing resource usage.

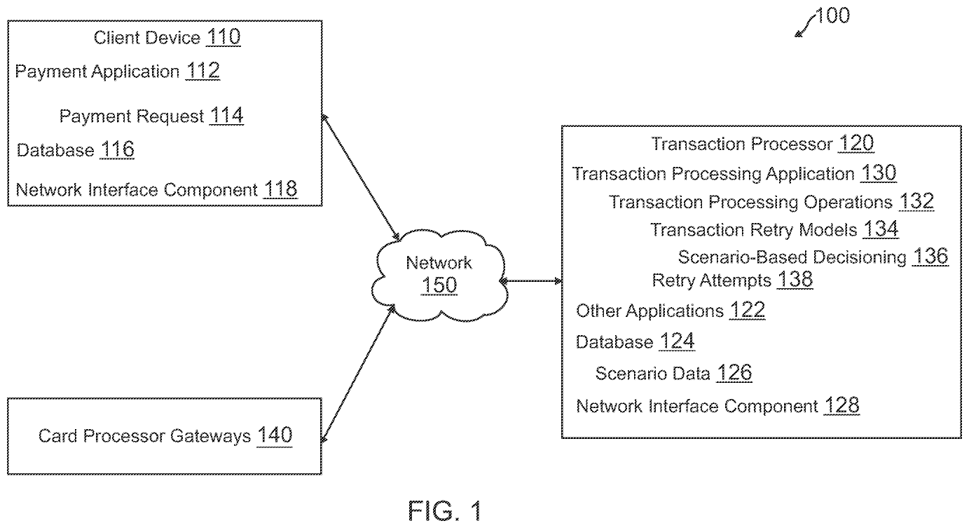

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110, a transaction processor 120, and card processor gateways 140 in communication over a network 150. Client device 110 may be utilized by a user to interact with transaction processor 120 over network 150, where transaction processor 120 may provide various computing services, data, operations, and other functions over network 150. In this regard, client device 110 may perform activities with transaction processor 120 for electronic transaction processing using a financial instrument, such as a payment card (e.g., credit or debit card). Transaction processor 120 may receive transaction data and may interact with card processor gateways 140 to process the transaction using the financial instrument. Processing of a transaction with card processor gateways 140 may fail or be declined, which may cause transaction processor 120 to determine whether to retry transaction processing with card processor gateways 140 using one or more ML models for scenario-based decisioning prior to failure or declination occurrence.

Client device 110, transaction processor 120, and card processor gateways 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with transaction processor 120 and card processor gateways 140. For example, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 contains a payment application 112, a database 116, and a network interface component 118. Payment application 112 may correspond to executable processes, procedures, and/or applications with associated hardware. In other embodiments, client device 110 may include additional or different modules having specialized hardware and/or software as required.

Payment application 112 may correspond to one or more processes to execute software modules and associated components of client device 110 to provide features, services, and other operations for a user over network 150, which may include electronic transaction processing features with transaction processor 120. In this regard, payment application 112 may correspond to specialized software utilized by a user of client device 110 that may be used to access a website or application (e.g., mobile application, rich Internet application, or resident software application) that may display one or more user interfaces that allow for interaction with transaction processor 120, for example, to process transactions. In various embodiments, payment application 112 may be used to access a website and interfaces (e.g., via a browser application, mobile application, rich Internet application, or resident software application) that may display one or more user interfaces that allow for interaction with the computing services of transaction processor 120 and/or a merchant marketplace, point-of-sale (POS) device, payment terminal, or the like for transaction processing of a payment request 114. As such, in various embodiments, payment application 112 may correspond to a general browser application configured to retrieve, present, and communicate information over the Internet (e.g., utilize resources on the World Wide Web) or a private network. However, in other embodiments, payment application 112 may include a dedicated application of transaction processor 120 or other entity that may access data for, present, and process payment request 114 via one or more interfaces.

Payment application 112 may be associated with account information, user financial information, and/or transaction histories for electronic transaction processing, including processing transactions using financial instrument or payment card data via card processor gateways 140. Payment application 112 may be utilized to enter, view, and/or process items the user wishes to purchase in a transaction, as well as perform peer-to-peer payments and transfers. In this regard, payment application 112 may provide transaction processing for payment request 114, such as through a user interface enabling the user to enter and/or view the items that the user associated with client device 110 wishes to purchase in a transaction. Thus, payment application 112 may also be used by a user to provide payments and transfers to another user or merchant, which may include transmitting payment request 114 or other data processing request to transaction processor 120 for processing and payment of the transaction. For example, payment request 114 may include and/or utilize user financial information, such as credit card data, bank account data, or other funding source data, as a payment instrument when providing payment information to transaction processor 120 for the transaction. Additionally, payment application 112 may utilize a digital wallet associated with an account with a payment provider as the payment instrument, for example, through accessing a digital wallet or account of a user through entry of authentication credentials and/or by providing a data token that allows for processing using the account. Payment application 112 may receive a receipt or other information based on transaction processing of the transaction and payment request 114. Further, additional services may be provided via payment application 112, including social networking, media posting or sharing, microblogging, data browsing and searching, online shopping, and other services available through transaction processor 120.

Client device 110 may also include other applications as may be desired in particular embodiments to provide features to client device 110. For example, these other applications may include security applications for implementing client-side security features, programmatic client applications for interfacing with appropriate application programming interfaces (APIs) over network 150, or other types of applications. Other applications on client device 110 may also include email, texting, voice and IM applications that allow a user to send and receive emails, calls, texts, and other notifications through network 150. In various embodiments, the other applications may include financial applications, such as banking applications. Other applications may include social networking applications, media viewing, and/or merchant applications.

The other applications may also include other location detection applications, which may be used to determine a location for the user, such as a mapping, compass, and/or GPS application, which can include a specialized GPS receiver that determines location information for client device 110. The other applications may include device interface applications and other display modules that may receive input from the user and/or output information to the user. For example, client device 110 may contain software programs, executable by a processor, including a graphical user interface (GUI) configured to provide an interface to the user. The other applications may therefore use devices of client device 110, such as display devices capable of displaying information to users and other output devices, including speakers.

Client device 110 may further include or be associated with database 116, which may store various applications and data and be utilized during execution of various modules of client device 110. Databases 116 may correspond to different types of data storage and components including cloud computing storage nodes, remote data stores and database systems, distributed database systems over network 150, and the like used to store various applications and data. Database 116 may store, for example, identifiers such as operating system registry entries, cookies associated with payment application 112 and/or other applications on client device 110, identifiers associated with hardware of client device 110, or other appropriate identifiers, such as identifiers used for payment/user/device authentication or identification, which may be communicated as identifying the user/client device 110 to transaction processor 120. Moreover, database 116 may store data for and/or provided with payment request 114 (e.g., payment data, tokens, account data, user or device data, etc.). Moreover, database 116 may store transaction data, transaction processing histories, or other information associated with the payment request 114 processed by transaction processor 120.

Client device 110 includes at least one network interface component 118 adapted to communicate with transaction processor 120, card processor gateways 140, and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Transaction processor 120 may be maintained, for example, by an online service provider, which may provide operations for use of service provided by transaction processor 120 including account and electronic transaction processing services. In this regard, transaction processor 120 includes one or more processing applications which may be configured to interact with client device 110 and/or card processor gateways 140 to process transactions, which may include transaction data and financial instrument data. In various embodiments, processing of transactions may encounter failures with card processor gateways 140, which may be retried based on intelligent decision-making by transaction processor 120 for different failure scenarios and retry strategies. In one example, transaction processor 120 may be provided by PAYPAL®, Inc. of San Jose, CA, USA. However, in other embodiments, transaction processor 120 may be maintained by or include another type of service provider.

Transaction processor 120 of FIG. 1 includes a transaction processing application 130, other applications 122, a database 124, and a network interface component 128. Transaction processing application 130 may correspond to executable processes, procedures, and/or applications with associated hardware. In other embodiments, transaction processor 120 may include additional or different modules having specialized hardware and/or software as required.

Transaction processing application 130 may correspond to one or more processes to execute modules and associated specialized hardware of transaction processor 120 to provide service for account usage, digital electronic communications, electronic transaction processing, and the like. In this regard, transaction processing application 130 may correspond to specialized hardware and/or software used by a user associated with client device 110 to utilize one or more services for electronic transaction processing. Transaction processing application 130 may be used by a user associated with client device 110 to establish a payment account and/or digital wallet, which may be used to process transactions. In various embodiments, financial information may be stored to the account, such as account/card numbers and information. A digital token for the account/wallet may be used to send and process payments, for example, through an interface provided by transaction processor 120. The payment account may be accessed and/or used through a browser application/extension and/or dedicated payment application executed by client device 110 and engage in transaction processing through transaction processing application 130.

In various embodiments, transaction processing application 130 may receive payment request 114 from client device 110, and process payment request 114 using transaction processing operations 132. For example, transaction processing operations 132 may utilize transaction and financial instrument data (e.g., payment card data) from payment request 114 to process the transaction with one of card processor gateways 140 corresponding to the payment (e.g., debit/credit) card or another financial instrument. Transaction processing application 132 may process the transaction and may provide transaction details for transaction authorization, approval, or denial. Transaction processing application 130 may further include messaging, social networking, media posting or sharing, microblogging, data browsing and searching, online shopping, and other services available through transaction processor 120.

However, during some transaction processing events and operations, a failure to process the transaction occurs, resulting in a notification, status, alert, code, or the like indicating the failure and/or a decline of payment request 114. For example, processing of payment request 114 may fail to be processed by or with a corresponding one of card processor gateways 140 (e.g., network issue, insufficient funds, invalid card or financial instrument identifier, not honoring the financial instrument, etc.). To handle such failures or declines and intelligently retry those transactions or other data processing operations with a high likelihood of success (e.g., meeting or exceeding a threshold, rule, or other bar), transaction processing operations 132 may be executed to determine whether to retry processing of payment request 114 for the transaction based on precomputed scores or other measures for scenario-based decisions on different failure scenarios and retrying with different processing strategies.

In this regard, transaction processing operations 132 may include transaction retry models 134 that may be used to compute scenario-based decisioning 136 for different failure or decline scenarios (e.g., failure/decline codes or other reason for processing failure) and using different retry strategies. Transaction retry models 134 may be trained to provide a predictive output, such as a score, likelihood, probability, or decision, associated with scenario-based decisioning 136 that attempts to quantify or measure whether retrying processing of the transaction may be successful with card processor gateways 140, which may be computed prior to the failure or decline occurring and stored for use during failure conditions and/or a failure state occurs. Further, thresholds, rules, and other requirements may be implemented with the scores to determine, based on the retry success likelihood or predictive score, whether each of the retry attempts should be executed.

For example, transaction retry models 134 may include ML or neural network (NN) models trained using training data for past failed transactions and whether retry attempts of those failed transactions were successful, which may correspond to transaction processing, failure, and/or retry data stored by database 124, which may include scenario data 126. When building transaction retry models 134, training data may be used to generate one or more classifiers and provide scores, decisions, predictions, or other outputs based on those classifications and an ML or NN model algorithm and/or trainer. Feature engineering and/or selection may be used to select a set of input features and their corresponding data used during training and inference phases of transaction retry models 134, such as scores for input data for those features, and whether those scores meet or exceed a threshold for retrying processing of a failed transaction using a particular retry strategy. For example, ML models for transaction retry models 134 may include one or more layers, branches of a tree, or the like, including an input layer/node(s), a hidden or intermediary layer/node(s), and an output layer/node(s) having however, different configurations may also be utilized. As many hidden or intermediary layers/nodes as necessary or appropriate may be utilized.

Each node for data processing in a decision tree, neural network, or the like may be connected to a node within an adjacent layer, pathway, branch, or the like, where a set of input values may be used to generate one or more output values or classifications. Within the input nodes, each node may correspond to a distinct attribute or input data feature that is used to train ML models for transaction retry models 134 and during model inference, for example, using feature or attribute extraction with payment request 114, scenario data 126, and the like. When training, the features may correspond to contextual features and/or roll-up features associated with past failed transactions, retry attempts of those transactions, retry strategies, and other related data. For example, contextual features for transactions and retries may be associated with a transaction amount, card or financial instrument processor, card or financial instrument type, a financial instrument usage (e.g., credit, debit, or the like), a merchant identifier, a retry strategy, a primary response or failure/decline code, or the like. Retry strategies may include retrying transactions using the same processing strategy and/or data (e.g., where network errors may occur), retrying using a NT, MC-ABU retries, secondary processor retries, retries using a zip code or skip address, or the like. As such, different ones of transaction retry models 134 may be trained and/or built for different retry strategies. Further, roll-up features may include those associated with past transactions that are not otherwise captured and may include a card's BIN, historical success/decline rates and/or patterns, and the like.

Nodes that are hidden or intermediary between the input and output of transaction retry models 134 may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden nodes may include different algorithms and/or different weights assigned to the input data and may therefore produce a different value based on the input values. The values generated by the hidden nodes may be used by the output layer node to produce one or more output values for transaction retry models 134 that attempt to classify whether a transaction that has failed transaction processing with card processor gateways 140 should be retried and re-processed (e.g., a predictive score or probability). Thus, when transaction retry models 134 are used to perform a predictive analysis and output, the input may provide a corresponding output based on the classifications trained for transaction retry models 134.

Transaction retry models 134 may be trained by using training data associated with scenario data 126 and ML model features. By providing training data to train transaction retry models 134, the nodes in the layers, branches, or the like may be trained (adjusted) such that an optimal output (e.g., a classification) is produced in the output based on the training data. By continuously providing different sets of training data, as well as penalizing transaction retry models 134 when the output of transaction retry models 134 is incorrect, transaction retry models 134 (and specifically, the representations of the hidden nodes) may be trained (adjusted) to improve model performance in data classification. Adjusting transaction retry models 134 may include adjusting the weights associated with each node in the hidden layers, branches, or the like. Thus, the training data may be used as input/output data sets that allow for transaction retry models 134 to make classifications based on input attributes. The output classifications for an ML model trained may be classifications and/or predictions of retry attempt success for a transaction processing failure of a transaction.

Once trained, transaction processing operations 132 may utilize transaction retry models 134 to determine whether to retry a failed transaction processing event with card processor gateways 140 for a transaction. Initially, on receipt of a transaction and/or entry to a transaction processing flow of transaction processing application 130, transaction processing operations 132 may begin transaction processing and call transaction retry models 134 to generate and/or determine scores or the like for scenario- based decisioning 136 of retry success or likelihood. Transaction processing operations 132 may extract features and attributes from payment request 114 and other data for the transaction corresponding to payment request 114. Transaction retry models 134 may then be invoked in order to generate a probability score or other predictive score/value for a likelihood of success when retrying processing of the transaction with card processor gateways 140. These scores may be computed for different failure scenarios (e.g., different failure or decline codes, as well as their corresponding contextual and/or transactional data), as well as for different retry strategies. The scores may then be cached, stored in short-term memory, or otherwise persisted for later use if a failure or decline occurs.

Transaction processing operations 132 may detect a transaction processing failure of the transaction and invoke a retry decision engine to determine whether to retry the transaction based on one or more scores and corresponding strategies for scenario-based decisioning 136. In various embodiments, the retry attempt of transaction processing may utilize a different processor and/or computing system of card processor gateways 140. The scores may be compared to a threshold, and if one or more scores meet or exceed a threshold, one or more retry attempts 138 may be executed for the corresponding strategies. Retry attempts 138 may utilize different strategies for retrying payment request 114 or other data processing request. For example, a primary processor may have attempted processing of the transaction, which failed, and thus a secondary processor may be designated for the corresponding one of retry attempts 138 for processing of the transaction.

In various embodiments, transaction processor 120 includes other applications 122 as may be desired in particular embodiments to provide features to transaction processor 120. For example, other applications 122 may include security applications for implementing server-side security features, programmatic client applications for interfacing with appropriate application programming interfaces (APIs) over network 150, or other types of applications. Other applications 122 may include server interface applications for an online server platform that output data to one or more devices. For example, other applications 122 may contain software programs, executable by a processor, including a graphical user interface (GUI) configured to provide interface data for display on devices.

Additionally, transaction processor 120 includes and/or is associated with database 124. Database 124 may store various identifiers associated with client device 110. Database 124 may also store account data, including payment instruments and authentication credentials, as well as transaction processing histories and data for processed transactions. Database 124 may store financial information and tokenization data. Database 124 may further store scenario data 126 and/or information used for execution of strategies for retry attempts 138. For example, database 124 may include or correspond to a strategy storage repository where strategies and corresponding data may be accessed and utilized for retry attempts 138. Although database 124 is shown as residing on transaction processor 120 as a database, in other embodiments, other types of data storage and components may be used including cloud computing storage nodes, remote data stores and database systems, distributed database systems over network 150 and/or of a computing system associated with transaction processor 120, and the like.

In various embodiments, transaction processor 120 includes at least one network interface component 128 adapted to communicate client device 110, card processor gateways 140, and/or other devices or server over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Card processor gateways 140 may be maintained, for example, by an online financial services and instrument providers, such as a financial institution, acquirers and/or issuers, credit, or payment card provider, service provider, or the like that provides financial instruments and accounts usable for payments during transaction processing. In this regard, card processor gateways 140 includes one or more processors executing data processing applications which may be configured to interact with transaction processor 120 to process transactions and issue payments, which may include processing transaction data and financial instrument data (e.g., card data for a payment card). In various embodiments, processing of transactions may encounter failures when processing data with transaction processor 120, which may be resolved through intelligent retry execution using scenario-based decisioning. In one example, card processor gateways 140 may be provided by VISA®, MASTERCARD®, AMERICAN EXPRESS®, DISCOVERY®, or the like. However, in other embodiments, card processor gateways 140 may be maintained by or include another type of financial service provider including banks, loan or credit providers, and the like.

In some embodiments, card processor gateways 140 of FIG. 1 include a multiple processors, where the processors may correspond to executable processes, procedures, and/or applications with associated hardware. In other embodiments, card processor gateways 140 may include additional or different modules having specialized hardware and/or software as required. The processors of card processor gateways 140 may process card data or other financial instrument data during electronic transaction processing, such as to provide a payment to another user, entity, and/or account. In this regard, the processors may be used to make payments to users, merchants, or other entities and their corresponding accounts, which may be made to an issuer and/or issuer computing and processing system for a user, entity, and/or account that is receiving a payment.

The processors of card processor gateways 140 may correspond to processors on a payment network used to process card or other financial data and provide payments to the corresponding acquirer (e.g., where payments are made to merchants or the like that receive money or other funds for an account) from the corresponding issuer (e.g., from customer payment instruments and accounts. Payments may be resolved by card processor gateways 140, and a payment may be provided to from the payers account and/or instrument to the payee account. The processors of card processor gateways 140 may be capable of different payment processing and/or retry strategies, such as those that may use NTs, MC-ABU, zip code or skip address processing, and the like. Where multiple processors may be used by one or more of card processor gateways 140, a primary processor may correspond to a card processor that is initially invoked by transaction processor 120 to process a transaction. If the primary processor fails to process or declines processing of the transaction, a secondary processor may be invoked during a retry attempt, if suggested or predicted to be of sufficient likelihood of success by transaction processor 120. Thus, the primary processor and/or secondary processor may correspond to separate software and/or hardware processing systems, which may include the same or similar processing features or separate processing features that provide financial instrument processing for transactions.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

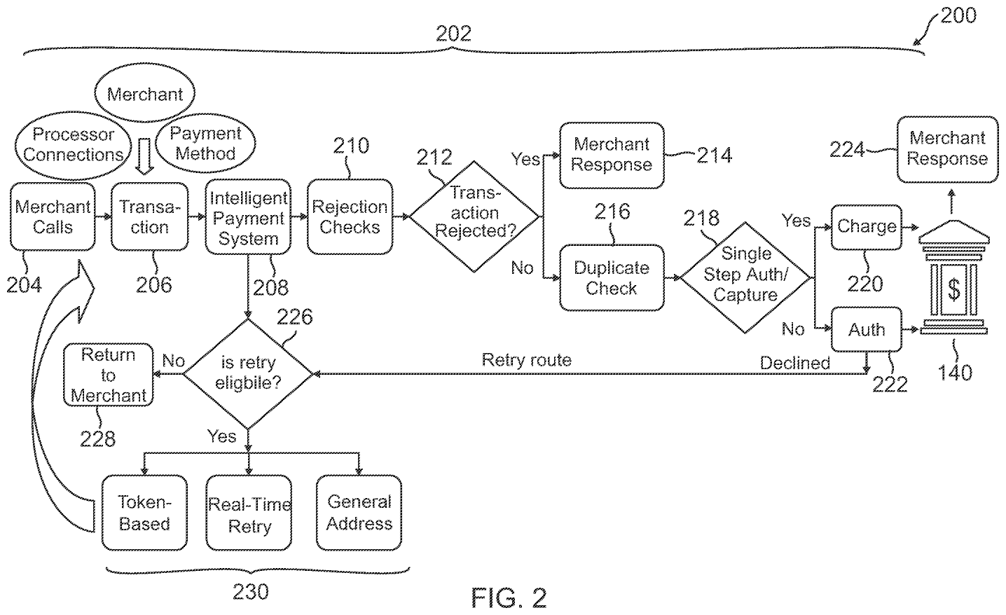

FIG. 2 is an exemplary computing environment 200 in which a machine learning model is deployed to determine whether to retry failed electronic transaction processing requests based on scenario-based decisioning, according to an embodiment. Computing environment 200 includes a payment processing flow 202 corresponding to the operations executed by transaction processor 120 discussed in reference to system 100 of FIG. 1. Computing environment 200 further includes card processor gateways 140 discussed in reference to system 100 that may interact with payment processing flow 202 during the processing of payments and retry attempts for data processing request failures or declines.

In computing environment 200, payment processing flow 202 of transaction processor 120 may be initiated in response to receiving merchant calls at block 204. The merchant calls may correspond to data processing requests, such as transaction and/or payment requests to be processed by a corresponding transaction processing application and/or system of transaction processor 120. As such, payment processing flow 202 may correspond to a process or series of operations of transaction processing application 130 of transaction processor 120. At block 206, a transaction is built from the merchant calls, which may be based on the merchant, processor connections for different payment processors (e.g., card processor gateways 140 or the like), and/or payment method provided and/or designated via the calls. At block 208, an intelligent payment system is then invoked to begin payment processing for the transaction. During invocation, the transaction may be processed and may continue processing until successful or rejected.

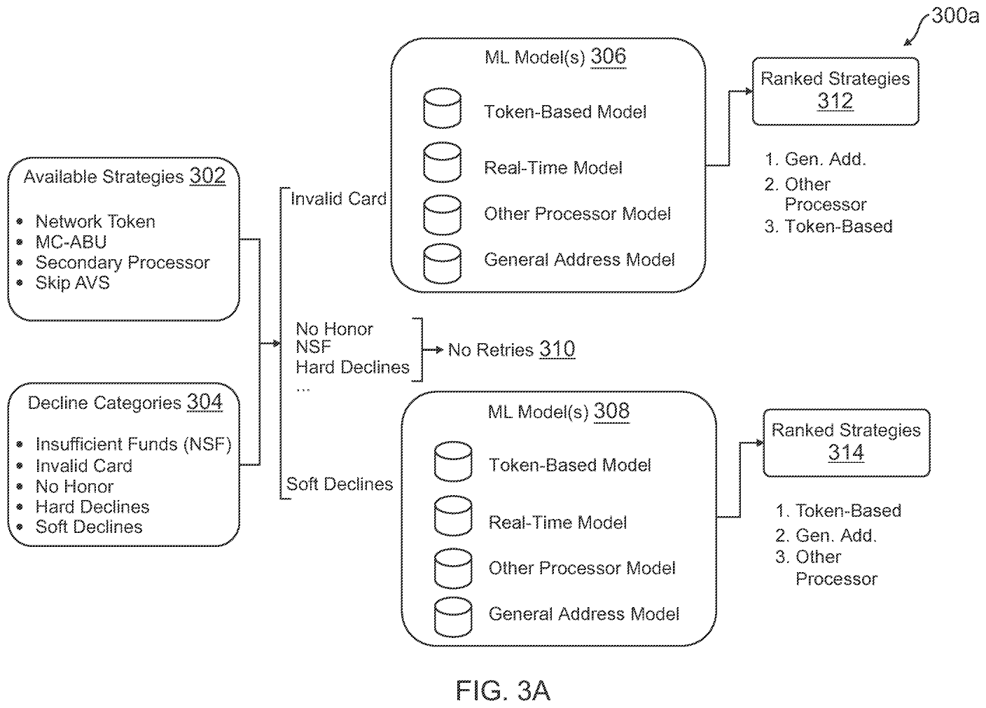

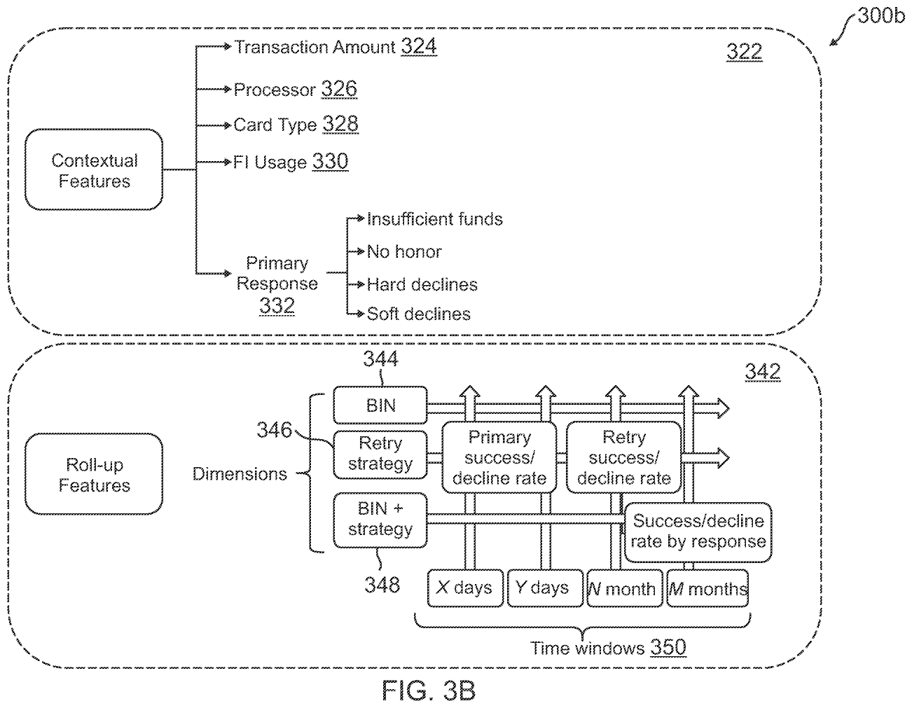

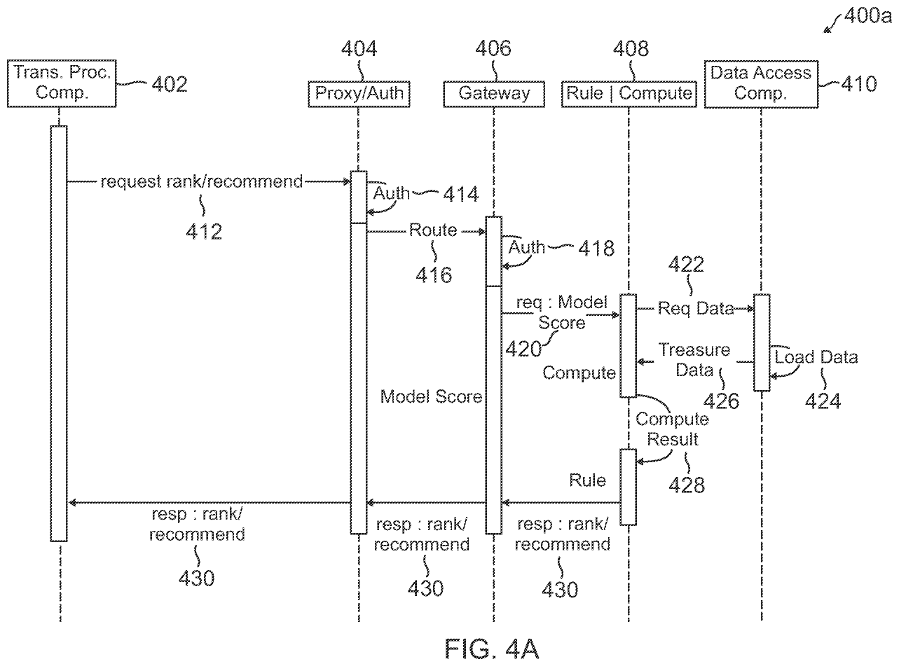

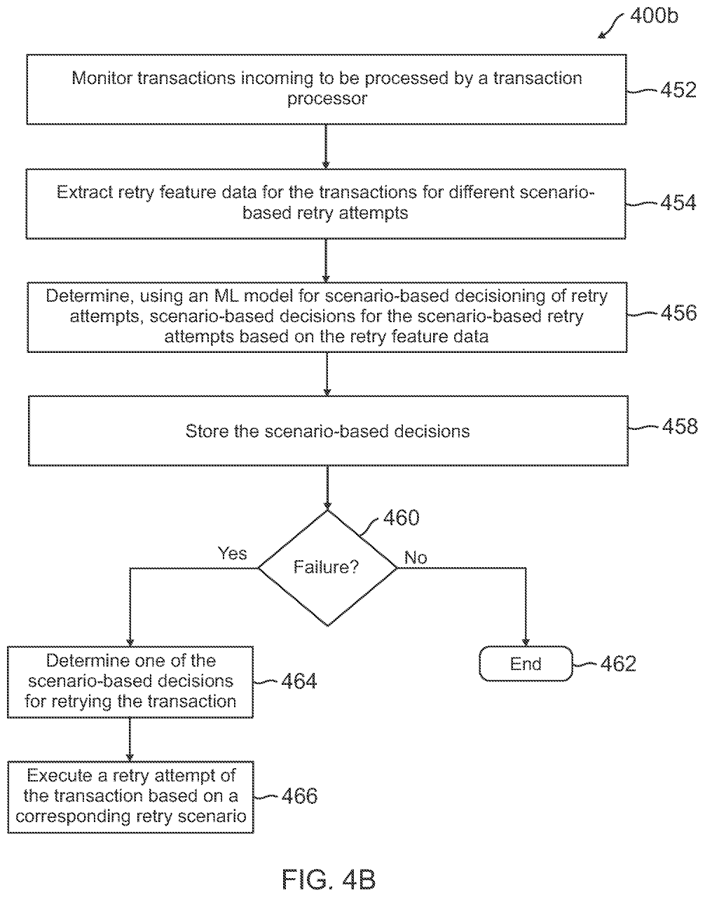

As such, at block 210, any rejection checks are performed to detect if the transaction is rejected for internal reasons and/or requirements, such as insufficient data, system error, etc., which may cause transaction processor 120 to decline the transaction outright. However, prior to or concurrently with the rejection checks, such as prior to or during transaction and payment processing, payment processing flow 202 may also proceed to a retry eligibility check at block 226, where retry eligibility may be determined using one or more ML models. Such models may be trained based on different failure or decline scenarios and for different retry strategies. As such, retry eligibility may be determined at block 226 by computing retry eligibility scores, decisions, or the like by the ML model(s), which may be compared to thresholds for scenario-based decisioning on retry eligibility and/or success, as well as stored (e.g., as scores or as decisions of retry eligibility and strategy) for later use. Training and inference using the ML model(s), such as based on the features for scenario-based decisioning prior to failure or decline occurrence, is discussed below with regard to FIGS. 3A-4B.

At block 212, the result of the rejection checks may be analyzed to determine if any initial rejections occur. If yes, payment processing flow 202 may return a merchant response at block 214 that declines or indicates failure of the transaction, such as due to error, insufficient data, fraud detection, risk score or profile, etc., as determined by transaction processor 120. However, if no initial rejections occur, payment processing flow 202 may continue to where card processor gateways 140 are invoked for payment processing using the provided payment method, funding instrument, or the like. In this regard, duplicate checks are performed at block 216 to prevent or minimize duplicate transactions and/or payments from being processed. A single step authentication or capture may be determined at block 218, where if such single step authentication/capture exists, a charge is automatically performed with a corresponding one of card processor gateways 140 at block 220. However, if no single step/authentication/capture exists, an authorization is determined at block 222 with the one of card processor gateways 140 processing the financial instrument information and providing the payment to the acquirer.

If successful with payment processing, a merchant response is processed and provided at block 224 by the one of card processor gateways 140 processing the financial instrument information and providing the payment. However, if the result of block 222 is a declined or otherwise failed transaction, payment processing flow 202 returns to block 226 using the previously computed and/or calculated scores, or their corresponding determinations of scenario-based decisioning (e.g., based on meeting/exceeding a threshold to indicate retry success and/or eligibility). Payment processing flow 202 may continue to block 228 if no retries are eligible, where the transaction is returned to the merchant as declined or failed to be processed. However, if a retry is eligible, payment processing flow 202 continues to block 230 to execute a corresponding strategy, such as a network token (NT), MC-ABU real-time retry, skip address verification service (AVS) data or fields (e.g., by skipping, relaxing, or making optional different fields required or processed by an AVS), or the like.

FIGS. 3A and 3B are exemplary diagrams 300a and 300b of machine learning models for predicting whether to retry a failed transaction processing request or other event based on features associated with failure and retry scenarios, according to an embodiment. Diagram 300a of FIG. 3A includes models that may process inputs to provide corresponding outputs for scenario-based decisioning of retry strategy success and/or eligibility, where the models may be executed by transaction processor 120 discussed in reference to system 100 of FIG. 1. In this regard, transaction processor 120 may execute the models in diagram 300a to determine whether to execute a retry attempt of a failed transaction with a backed processing gateway and/or network, such as card processor gateways 140, based on predetermined scores or decisions for retry success and/or eligibility.

In diagram 300a, available strategies 302 and decline categories 304 may correspond to the initial input utilized with transaction data for determining scores or other outputs used for retry attempts and/or eligibility decisioning, such as whether to execute a retry of a failed or decline transaction. In this regard, available strategies 302 for retrying a transaction, payment, or other data processing request after decline and/or failure of processing may include using a token or other tokenization of card and/or transaction data (e.g., an NT), using a real-time billing component or processor (e.g., MC-ABU), using another processor of the card processor including secondary processor of the card processor that processes retries or other card processing transactions, performing a generalized address strategy using a zip code or other generalization, relaxation, or ignoring/skipping data for an AVS (e.g., making certain address fields blank, null, skipped, or optional), or other retry strategy. Such strategies may also be ranked according to decline categories 304 and/or after score determination. Decline categories 304 may include those codes, categories, or identifies returned when a transaction and/or payment fails to be processed, such as for insufficient funds, invalid card or card identifier, “no honor” or a refusal to honor and issue payments using the card, hard declines (e.g., for possible fraud, lost card, etc.), soft declines (e.g., for temporary authorization failures such as unusual transaction, technical issues, adherence to standards or regulations, etc., where the payment may be authorized but transaction declined for other reasons), or other failure. Additional input with decline categories 304 may include the underlying transaction data and the like, which may be provided when selecting the corresponding retry strategy models to execute.

Executable ML models for different strategies may be separated and/or ranked according to their corresponding decline or failure scenario, such as an invalid card scenario, soft decline scenario, or the like. As such, in diagram 300a, the models are shown split into ML model(s) 306 and ML model(s) 308, where a further category where no retries 310 are attempted for certain ones of decline categories 304 (e.g., no honor, insufficient funds (NSF), hard declines, and the like). Each model in ML model(s) 306 and 308 may correspond to one of available strategies 302, such as a token-based (e.g., NT) retry model, a real-time retry (e.g., using MC-ABU or the like) model, another processor or secondary processor retry model, a generalized address strategy model (or other strategy that relaxes, ignores, or skips address verification and/or an AVS, such as a zip code-based model), or the like.

In this regard, ML model(s) 306 may be invoked for different ones of available strategies 302 for a particular one of decline categories 304 (e.g., invalid card), which may occur prior to the failure or decline and as such, other ones of decline categories 304 may also have corresponding models run for score determination and strategy ranking/selection. For example, for soft declines, ML model(s) 308 may be run for different ones of available strategies 302. Thus, prior to failure detection, ML model(s) 306 and 308 may be run for invalid card declines and soft declines, respectively, to compute scores and determine ranked strategies 312 and ranked strategies 314, respectively. Ranked strategies 312 and 314 may be ranked differently depending on their corresponding input and output scores, allowing for decisioning based on the failure scenario. For example, for ranked strategies 312 resulting in an invalid card failure scenario, a generalized address or other generalization of AVS data retry strategy may be ranked first, secondary or other processor second, and token-based third. However, with ranked strategies 314 for a soft decline failure scenario, a token-based strategy may be ranked first, generalized address second, and another processor third.

Referring now to FIG. 3B, diagram 300b shows different ML model features that may be used for model training and inference for ML models that predict retry success likelihood and/or eligibility. In this regard, diagram 300b includes contextual features 322, which correspond to a set of selected and/or engineering features associated with particular contextual information for a transaction and/or transaction failure/decline. In this regard, contextual features 322 may include a feature for a transaction amount 324, a processor 326 or other processor for a payment card or another financial instrument, a card type 328 or financial type of financial instrument, a financial instrument usage 330 (e.g., for credit payments, debit payments, transfers, withdrawals, check payments, etc.), and/or a primary response 332 for a code or other identifier of why a request failed or was declined. Primary response 332 may correspond to insufficient funds, no honor, hard declines, soft declines, or the like. For contextual features 322, corresponding data categories or table fields may be identified and may be used to extract corresponding data that may be processed by the ML model when outputting a score or other decision for executing retries of different failure scenarios.

In addition to contextual features 322, roll-up features 342 may also be added and/or utilized during ML model training and inference, which may provide additional data for more accurate and/or precise scoring and scenario-based decisioning of retry attempt success likelihood and/or eligibility. In this regard, roll-up features 342 include features associated with a BIN 344, a retry strategy 346, and a BIN+strategy 348. Each of these features may also be measured or determined over time windows 350, such as at different times for a primary success/decline rate, retry success/decline rate, and/or success/decline rate by response for each of BIN 344, retry strategy 346, and BIN+strategy 348. For roll-up features 342, and over time windows 350, corresponding data categories or table fields may be identified and may be used to extract corresponding data that may be processed by the ML model when outputting a score or other decision for executing retries of different failure scenarios.

FIGS. 4A and 4B are flowcharts 400a and 400b for scenario-based decisioning by machine learning models for data processing retry success, according to an embodiment. Note that one or more steps, processes, and methods described herein of flowcharts 400a and 400b may be omitted, performed in a different sequence, or combined as desired or appropriate.

Flowchart 400b in FIG. 4B includes steps executed by transaction processing component 402 busing one or more ML models, such as those executed by rule/compute 408, as discussed with reference to flowchart 400a of FIG. 4A. As such, different portions of the steps of flowchart 400b are shown as being performed by, on, or with such components, such as those components, applications, and platforms of transaction processor 120 in system 100 of FIG. 1. In this regard, flowchart 400a shows interactions between a transaction processing component 402, a proxy/authenticator 404, a gateway 406, a rule/compute 408, and a data access component 410. Such components may be provided by transaction processor 120 when determining scores or other outputs for scenario-based decisioning for retry attempts and retry success likelihood.

At step 412 of flowchart 400a, rank and recommendations for retry attempts and/or success likelihood are requested by transaction processing component 402 to a system that determines scenario-based decisioning data processing retry success, which may include and/or utilize proxy/authenticator 404, gateway 406, rule/compute 408, and data access component 410. In this regard, when transactions are received, detected, and/or streamed into a data processing system for processing, storage, and the like, the system may be invoked to compute or otherwise determine one or more scores for retry success likelihood, such as for one or more ML models for different retry strategies and/or failure scenarios. As such, transaction processing component 402 may call proxy/authenticator 404 at step 412.

At step 414, proxy/authenticator 404 may perform an initial authentication of the incoming data and the call to verify the data for the transaction and/or call. The authentication may validate that the call came from a verified and/or authenticated caller endpoint or other client calling the system for scenario-based decisioning prior to data processing failure or decline. At step 416, the data for the call is routed from proxy/authenticator 404 to gateway 406 for the system, which may serve as the gateway endpoint and/or orchestrator for retry success scoring and/or decisioning. As such, gateway 406 may perform a further authentication at step 418 for the call.

At step 420, gateway 406 then transmits a model score request to rule/compute 408, which may correspond to the ML model for retry success scoring and/or decisioning for different scenarios. The request at step 420 may correspond to a call to rule/compute 408 that initiates an ML engine to execute processes for the ML model and generate a predictive score or other output for the scenario-based decisioning for the corresponding strategy. To execute the ML model and provide a decision, rule/compute 408 then calls data access component 410, at step 422, to obtain data for the transaction, retry strategy, and other scenario data that may be used for the decisioning. The call may correspond to a database query or the like or may correspond to a request for corresponding data from another processor that may determine such data for determining a score or the like of retry success.

At step 424, data access component 410 loads the data, such as from one or more databases, caches, data streams/lakes, or the like. The loaded data may correspond to data for the features of the ML model, such as data for contextual and/or roll-up features and may be data available at the current time of the transaction being received and/or processed (e.g., prior to the failure of the transaction). As such, at step 426, feature data is returned from data access component 410 to rule/compute 408 to process using the ML model. Rule/compute 408 may then compute a result, at step 428, which may correspond to a predictive score or the like that provides a scenario-based decision prior to a failure or decline of the transaction that predicts likelihood of retry success using a corresponding retry strategy for the ML model. The score may therefore be used to compare to a threshold and/or other rules to determine whether to execute the retry if a failure or decline occurs, such as if there is a sufficient likelihood of success. At step 430, the rank/recommendation result is then returned from rule/compute 408 to transaction processing component 402 via gateway 406 and proxy/authenticator 404. The score may then be stored for later use if a failure or decline occurs.

Flowchart 400b shows another flowchart for scenario-based decisioning by machine learning models for data processing retry success, according to an embodiment. At step 452 of flowchart 400b, transactions incoming to be processed by a transaction processor are monitored. A monitoring component of an incoming stream or pipeline of data processing requests, such as transactions and payment requests, may be monitored to detect new requests to be processed. These may come from merchants and merchant devices or systems (e.g., POS devices, merchant servers, websites, applications, etc.), as well as from customers and other end users (e.g., computing devices including mobile smart phones, applications, websites, etc.).

At step 454, retry feature data for the transactions for different scenario-based retry attempts is extracted. The data may correspond to data for ML features, including data associated with contextual and/or roll-up features for ML model(s). As such, the data may include transaction data, financial instrument data, and/or processing data. For example, the transaction data may include data for features and/or attributes that is extracted similarly to be processed when determining when to execute a retry of a failed transaction. The transaction data may include data available from transaction tables including a transaction amount, a processor, a card type or other type of financial instrument, a usage type of the financial instrument, and the like. Other data may include financial instrument and/or account numbers, authentication data (e.g., a PIN, card verification code, etc.), billing information and address, selected card or instrument processor, network tokens and/or data communications, encryption parameters and/or keys, BINs, retry failure or decline codes, and the like.

At step 456, using an ML model for scenario-based decisioning of retry attempts, scenario-based decisions for the scenario-based retry attempts are determined based on the retry feature data. An ML model for predictive retry attempt likelihood may be trained using training data for features used to predict retry success likelihood and/or usable with the corresponding ML algorithm. The ML algorithm may be selected such as a GBM or Light GBM model, an XG Boost model, a random forest model, or a tree-based algorithm model. Thus, once the model is deployed, the model may be used, with any other trained models for different scenario-based retries, to determine the scenario-based decisions. These decisions may be determined based on the input data for the model features. Further, the decisions may be determined prior to any failures or declines being detected or occurring such that the decisions may be made available for faster and more real-time retry decisioning when failures/declines occur. The scenario-based decisions may each be based on scenarios for failures/declines, as well as retry strategies or other scenarios for retrying the transactions or other requests.

At step 458, the scenario-based decisions are stored. The decisions may be stored in short-term memory to be made available quickly and/or locally for when failures/declines of transaction processing or other request processing may occur. However, other storage mechanisms and/or components may also or instead be used. At step 460, it is detected whether a transaction has resulted in a failure or decline, such as when processing with a card processor is detected. The transaction may have failed due to a data processing error, failure of a process or component, and/or network communication issue during transaction processing. This may occur when processing the transaction with a card processing system having the card processor, such as a backend card processing gateway and/or network, fails or is declined, and a resulting error or decline code or status is returned.

At step 462, if no failure has occurred, flowchart 400b ends and no retries are necessary. This may further include deleting or removing from storage any corresponding decisions or scores for retry attempt likelihood or execution for successful transactions or other processing requests. However, if a failure occurs, flowchart 400b continues to step 464, where one of the scenario-based decisions for retrying the transaction is determined. The predictive score may further correspond to a probability or likelihood of the failed transaction being successful if retried with the card processor or a secondary card processor for the card processing system, or other score of retry success likelihood using a corresponding retry strategy. As such, the score may be compared to a threshold score or likelihood, which may be used to determine whether to execute the retry using that strategy (e.g., for meeting or exceeding the threshold). If sufficient success of a retry is likely and/or is recommended based on the score, at step 466, a retry attempt of the transaction is executed based on a corresponding retry scenario. The retry attempt may be executed according to the scenario and strategy predicted to be successful or having a sufficiently high likelihood of success to warrant execution. As such, the failed or declined transaction or request may be retried with another processing strategy, component, or the like (e.g., NT, MC-ABU, skip/zip address, secondary processor, etc.). If the retry attempt at step 466 still results in a failure, the process may continue by using data of the failed retry attempt to determine whether another retry attempt should be performed, using the same or similar analysis described above. If a further retry attempt is determined to yield a threshold likelihood of success, the further retry attempt may be attempted, which may use the same or different progressing strategy, component, or the like used in the prior retry attempt. This process may continue until a determination is made that no more retry attempts should be performed or until a transaction has been successfully processed through a retry attempt.

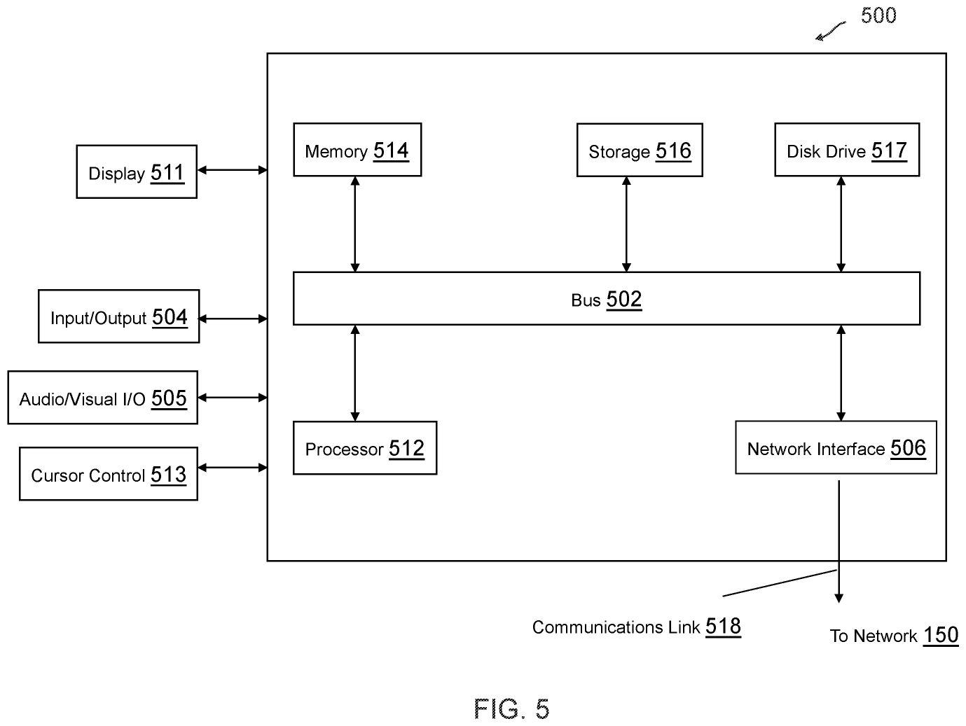

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD- ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A transaction processor system comprising:
a non-transitory memory; and
one or more hardware processors coupled to the non-transitory memory and configured to read instructions from the non-transitory memory to cause the transaction processor system to perform operations comprising:
monitoring transactions being processed by a transaction processing component associated with the transaction processor system;
extracting, from transaction data for the transactions and processing scenario data for processing the transactions by the transaction processing component, retry feature data for a plurality of features used by a machine learning (ML) model that is trained to determine scenario-based decisions on retrying a processing of one or more transactions of the transactions;
determining, using the ML model, the scenario-based decisions for retrying the processing of the one or more transactions based on the retry feature data and the plurality of features, wherein the scenario-based decisions are determined simultaneously with the transaction being processed by the transaction processing component;
storing the scenario-based decisions while the one or more transactions are being processed by the transaction processing component;
detecting that a first transaction of the one or more transactions has failed to process by the transaction processing component; and
determining whether to execute a retry attempt of the first transaction based on one of the scenario-based decisions corresponding to the first transaction.

2. The transaction processor system of claim 1, wherein the scenario-based decisions are associated with failure scenarios for retrying processing of the transactions, and wherein each of the failure scenarios are associated with a cause of a corresponding one of the transaction processing failures and a retry process for the corresponding one of the transaction processing failures likelihood of success based on why the first transaction failed and how processing of the first transaction can be retried.

3. The transaction processor system of claim 1, wherein prior to the monitoring, the operations further comprise:
determining the plurality of features include contextual features associated with transaction table data for transactions and roll-up features associated with at least one of a bank identification number (BIN), historical successes and historical failures for different retry strategies, or primary failure response codes; and
training the ML model using training data features extracted from training data associated with past transactions and the plurality of features.

4. The transaction processor system of claim 1, wherein the determining whether to execute the retry attempt is further based on decision rules associated with at least one of a merchant to the first transaction, a cost of the first transaction, a lost revenue from the first transaction failing to be processed, a value of a customer to the first transaction, or a retry execution strategy associated with the first transaction.

5. The transaction processor system of claim 1, wherein the operations further comprise:
in response to determining to execute the retry attempt, executing the retry attempt of the first transaction using a retry strategy associated with the one of the scenario-based decisions.

6. The transaction processor system of claim 5, wherein the executing the retry attempt is performed in response to the one of the scenario-based decisions meeting or exceeding a threshold likelihood for a retry success of the retry attempt, and wherein the executing the retry attempt is performed in real-time at a time of processing of the first transaction without causing a delay from determining the one of the scenario-based decisions at the time of the processing of the first transaction.

7. The transaction processor system of claim 5, wherein, prior to the executing the retry attempt, the operations further comprise:
determining the retry strategy from a plurality of retry strategies based on a highest success rate of the retry strategy for the first transaction after failing to be processed by the transaction processing component and retry strategies supported by a merchant corresponding to each of the transaction.

8. The transaction processor system of claim 1, wherein the detecting is based on one of a decline to process the first transaction by a card processor in communication with the transaction processing component or a failure to respond or process data by the card processor or the transaction processing component when processing the first transaction.

9. The transaction processor system of claim 1, wherein the ML model comprises one of a token-based ML model, a real-time billing service-based model, a retry with optional address fields and/or zip code-based model, or a retry with a different processor-based model.

10. The transaction processor system of claim 1, wherein the scenario-based decisions are associated with a plurality of transaction decline codes by a third-party processing system and a plurality of retry strategies with the third-party processing system.

11. A method comprising:
monitoring a transaction processing attempt to process a transaction by a transaction processor;
extracting feature data for features of a machine learning (ML) model trained to predict retry success likelihoods for retries of different transactions from failures to process the different transactions by the transaction processor, wherein the retry success likelihoods are based on scenarios causing the failures of the different transactions;
determining, by the ML model during the transaction processing attempt, a first retry success likelihood for retrying a processing of the transaction based on the feature data; and
storing the first retry success likelihood score in association with the transaction.

12. The method of claim 11, further comprising:
determining, by another ML model trained for a separate retry strategy from the ML model, a second retry success likelihood for retrying the processing of the transaction based on the feature data; and
storing the second retry success likelihood score in association with the transaction and the first retry success likelihood score.

13. The method of claim 11, further comprising:
retrying the processing of the transaction using a retry strategy associated with the ML model, the first retry success likelihood score, and a merchant corresponding to the transaction.

14. The method of claim 11, wherein the ML model comprises one of a token-based ML model, a real-time billing service-based model, a retry with optional address fields and/or zip code-based model, or a retry with a different processor-based model.

15. The method of claim 11, wherein the first retry success likelihood is associated with a transaction decline code by a third-party processing system and a retry strategy with the third-party processing system.

16. A method comprising:
receiving training data for a machine learning (ML) model to be trained using an ML model training technique, wherein the training data is associated with a plurality of past scenarios for past transaction processing failures and past retries of the past transaction processing failures;
determining a plurality of features for the ML model for scenario-based decisions on retrying processing of transactions if the transactions fail to process by a transaction processor based on scenarios for transaction processing failures, wherein the scenarios are each associated with a cause of a corresponding one of the transaction processing failures and a retry process for the corresponding one of the transaction processing failures;
extracting feature training data for the plurality of features from the training data and a feature extraction process; and
training the ML model for determining the scenario-based decisions on retrying processing of the transactions.

17. The method of claim 16, further comprising:
deploying the ML model with a transaction processor; and
monitoring transactions to be processed by the transaction processor for retry eligibility after processing failure.

18. The method of claim 17, further comprising:
determining scores for the retry eligibility based on a likelihood of retry success for each of the transactions based on different failure scenarios and different retry strategies.

19. The method of claim 16, wherein the ML model comprises one of a token-based ML model, a real-time billing service-based model, a retry with optional address fields and/or zip code-based model, or a retry with a different processor-based model.

20. The method of claim 16, wherein the plurality of features are associated with at least a transaction decline code by a third-party processing system and a retry strategy with the third-party processing system.
